(19) United States
(12) Patent Application Publication
(10) Pub. No.: US 2010/0066690 A1
(43) Pub. Date: Mar. 18, 2010

(54) DIGITIZING TABLET DEVICES, METHODS AND SYSTEMS

(76) Inventor: Darin BEAMISH, Puyallup, WA (US)

Correspondence Address: DWC LAW FIRM, P.S., P.O. BOX 3041, SEATTLE, WA, 98114-3041, US

(21) Appl. No.: 12/468,048

(22) Filed: May 18, 2009

Related U.S. Application Data
(60) Provisional application No. 61/054,133, filed on May 17, 2008.

(51) Int. Cl. G06F 3/041

(52) U.S. Cl. 345/173

(57) ABSTRACT

Digitizing tablet methods and systems are provided. Various embodiments of the digitizing tablet include a pointer, an input surface and a display. In some embodiments, both an inner and outer portion of the input surface can be associated with indicia, each of the indicia being operable to trigger a function or mode of operation, or both. In some embodiments, the inner surface can also be mapped to an image projectable on a display device. A plurality of template sheets can be attached to the input surface, interchangeably or simultaneously, for identifying the location of indicia and live areas on which a user can annotate.

### CROSS-REFERENCE TO RELATED APPLICATIONS

This application claims the benefit of U.S. Provisional Patent Application No. 61/054,133, filed May 17, 2008, which is incorporated herein by reference in its entirety.

### BACKGROUND OF THE INVENTION

1. Field of the Invention

The present invention relates to digitizing tablets, and more particularly, to digitizing tablets having wireless communication capabilities and input surfaces with flexible mapping.

2. Description of Related Art

Digitizing tablets are widely commercially available. A typically digitizing tablet can comprise a stylus, or pen, and an input surface capable of detecting a position of the stylus relative to the input surface. The position detection information can be compared against layout information for the input surface. For example, the layout information can correspond to images on a display device, such that the position of the stylus relative to the input surface can be used to designate an annotation position on the image, such as in the case where the digitizing tablet is used to write and the written annotation is displayed on a display device. The layout information can also correspond to function indicia, such that the position of the stylus relative to the input surface can be used to initiate functions. Nonetheless, the flexibility of the input surface is limited for many commercially available digitizing tablets.

### BRIEF SUMMARY OF THE INVENTION

Digitizing tablet systems are provided. Some embodiments comprise a digitizing tablet or tablet, having an input surface. In some embodiments, the input surface has no display functions, and the graphical results of some actions taken using the tablet can be observed on one or more connected display devices. A plurality of different templates can be provided, each of which can be printed on sheet material, and can be interchangeably or simultaneously attached or secured to the input surface, with at least two of the templates also being capable of being layered as overlying templates for simultaneous, or alternate, use in controlling the tablet system. In some embodiments, a live area marked on a template, which can be mapped to a graphical image on a display, can be configured differently for different interchangeable templates. At least a first, or main, template can be marked with indicia for use in controlling functions or modes executable by the tablet system.

At least some indicia of the first template are located proximate a perimeter of the template. A second template, and the first template, can each contain at least one printed live area with dimensions of the live area being different or the same. The live area occupies only a portion of the respective template and can be mapped to a graphical image displayable on a commonly viewable display device, or common display, viewable by audience members for use in selecting a location on the live area corresponding proportionally to a location on the graphical image displayed on the common display. The graphical image can comprise text, graphics, or both. At least one of the templates can be printed on transparent sheet material. Also, in some embodiments, at least one of the templates is printed on opaque material.

In some embodiments, multiple templates are usable with the tablet of the system by being simultaneously secured in layered, or overlying, fashion over the input surface of the tablet.

In some embodiments of the present invention, the digitizing tablet of the system comprises a compact private display, such as an LCD, which is disposed in a physically separate location from an input surface of the digitizing tablet. The private display can display private information, such as lists, menus, the status of selections made by a user, etc., to assist a user in the process of making selections using the tablet when selecting indicia on at least one of the templates (or input keys on another location of the tablet), without displaying the private information to audience members via the common display. A result of the selection can be displayed on the common display for view by audience members.

Methods of using the digitizing tablets and systems of the present invention are also provided, along with software and software products for use in configuring and operating the digitizing tablet and system.

In some embodiments of the present invention, a portable communication device, which can be, for example, the tablet for some embodiments of the present invention, or a wireless audience response remote equipped with a keypad, comprises at least one input member (a digitizing tablet input surface, keys, or both) and a compact private display provided on the portable communication device. The compact display is operable to display a plurality of lists of identifiers corresponding to items or files (which an be stored remotely on a memory of a computer). The portable communication device is wirelessly communicatively linked to the computer. A user of the communication device can scroll through each list of identifiers for selecting an item when the list is displayed on the compact display of the portable communication device. Each of the lists of identifiers can be separately displayable on the compact display as a function of a selection made by the user, a current activity or a status of the activity.

In further embodiments of the present invention, a digitizing tablet system includes a tablet having an input surface with a plurality of sensing members for detecting the position of a pointer proximate the input surface and for generating position detection signals. A pointer is provided. A processor, which can be a remote processor, is operable for receiving position detection data based on the position detection signals and for comparing the position detection data against layout information for the input surface, the layout information including locations of indicia selectable using the pointer for initiating a function or mode of the tablet system. At least one of the locations of indicia alternatively can be all or part of a live area that is mapped to a location on a graphical image displayable on a commonly viewable display, depending on a selected mode of the tablet system. With respect to one or more particular indicia, a user can toggle between a mode that initiates the indicia for use in executing a function or mode of the tablet system, and a mode wherein the location of the indicia is mapped to a graphical image such that the location of the indicia is usable for marking on a displayable image or controlling a cursor on the image.

In some embodiments of the present invention, a digitizing tablet system comprises a tablet having an input surface and at least one template sheet which can be secured to the input surface. The template sheet can have a plurality of printed indicia for defining locations on the input surface that are usable for controlling a function or mode of the tablet system. The template sheet can also have at least one marked section representing a live area that is proportionally mapped to a graphical image displayable on a commonly viewable display. The template sheet can be interchangeable with one or more other template sheets having a differently configured live area. One or more of the interchangeable templates sheets can be configured by a user. A user can create the template sheets, associate the template sheets with layout information storable on a memory of a computer, and print the template sheets for use with the tablet. One or more of the template sheets can be transparent, and one or more of the template sheets can be opaque.

### BRIEF DESCRIPTION OF SEVERAL VIEWS OF THE DRAWINGS

FIG. 1 is a plan view of an embodiment of a digitizing tablet of the present invention.

FIG. 2 is a diagram showing major components of an audience response system for use in some embodiments of the present invention.

FIG. 3 is a plan view of an embodiment of a main template for use with the digitizing tablet of FIG. 1.

FIG. 4 is a plan view of the main template of FIG. 3 combined with an overlying or underlying keyboard template for use with the digitizing tablet of FIG. 1 in some embodiments of the present invention.

FIG. 5 is a plan view of the main template of FIG. 3 combined with an overlying or underlying template having a live area mapped to a display for use in some embodiments of the present invention.

FIG. 6 is a plan view of the main template of FIG. 3 combined with an overlying or underlying template having a plurality of locations corresponding to slides in a presentation for use in some embodiments of the present invention.

FIG. 7 is a plan view of the main template of FIG. 3 combined with an overlying or underlying template having a plurality of locations corresponding to slides in a presentation, and further combined with a second overlying or underlying template having a keyboard image for use in some embodiments of the present invention.

FIG. 8 is a plan view of the main template of FIG. 3 combined with an overlying or underlying template having a plurality of separate live areas for use in some embodiments of the present invention.

FIG. 9 is a plan view of the display 8 for tablet 2, for some embodiments of the present invention, showing a display view having selectable options for browsing a directory of the computer 2 or for viewing a list.

FIG. 10 is a plan view of the display 8 for tablet 2, for some embodiments of the present invention, showing an example list.

FIG. 11 is an association diagram showing example associations for a file list, for use with some embodiments of the present invention.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available structures, hardware, firmware, software and wireless protocol associated with digitizing tablets operable with pointers and audience response systems, have not been described in detail to avoid unnecessarily obscuring the descriptions of the embodiments of the invention.

In some portions of this description, “pointing” to a location on the input surface 4 of the digitizing tablet 2, or “selecting” an indicia location or other location on the input surface, can mean positioning a tip of the pointer 6 within a pre-designated or calibrated lateral and vertical proximity of the location, as will be appreciated by those skilled in the art after reviewing this disclosure.

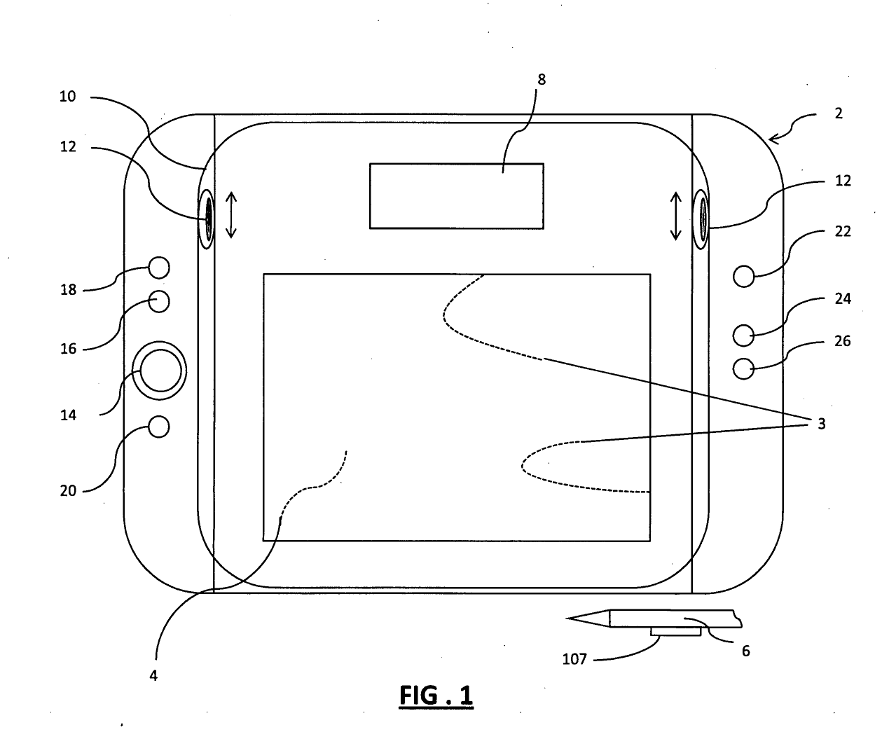

Referring to FIG. 1, the tablet 2 of the present invention can have an input surface 4 that is separate from a tablet display 8, which can be a liquid crystal display. However, as will be understood by one skilled in the art after reviewing this disclosure, various other tablet structures are contemplated, such as one having an integrated input surface and LCD, in which the LCD is a touch screen surface. Also, in some embodiments, the tablet has no display device.

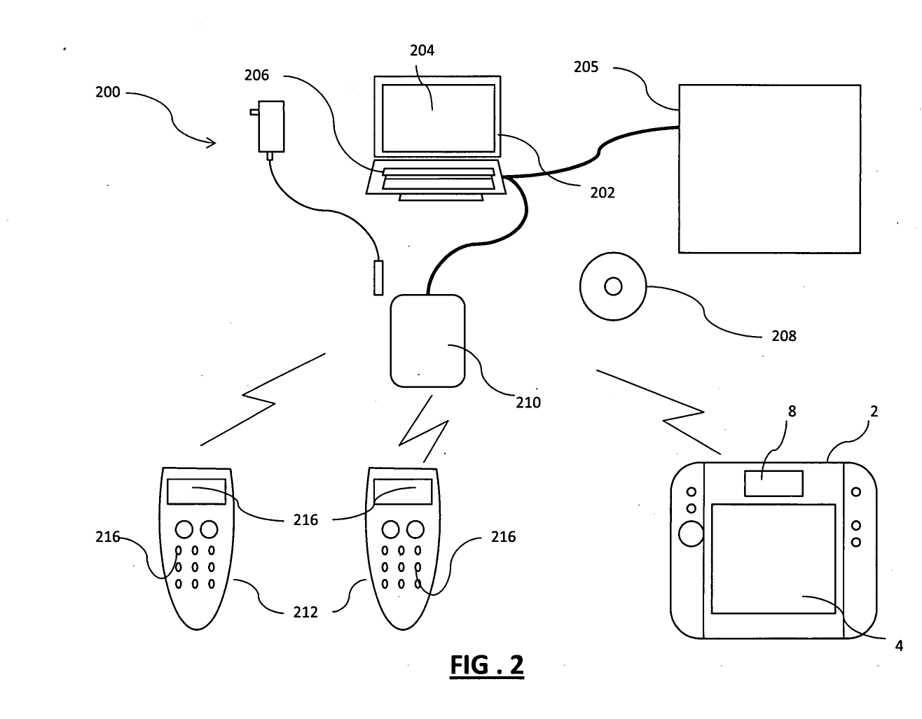

The discussion below discloses, among other things, using the tablet 2 of the present invention apart from, or in connection with, a wireless audience response system 200 (See, e.g., FIG. 2). In some embodiments, a plurality of audience members can each have a tablet, with each of the tablets being in communication in a wireless network. In other embodiments, only a presenter is provided with a tablet 2. Furthermore, in some embodiments of the present invention, although the presenter or audience members can be in possession of a tablet 2 of the present invention, other participants can be provided with audience response keypads, or remotes 212. Remotes 212 having wireless network communication capabilities are widely available, such as, for example, the QWIZDOM Q4 handheld remote. The tablet 2 device can also be used as a stand-alone wireless presenter device in some embodiments, such as, for example, for controlling presentation slides stored on a computer 202.

In some embodiments of the present invention, wherein the tablet 2 is used as part of an audience responses system 200, a presenter can pose inquiries verbally, or on a common display 205 viewable by audience members, and audience members can respond by providing input to the audience response keypads, or remotes 212 (or tablets 2 in some embodiments of the present invention) with the responses being received and processed at a computer 202, then stored and displayed or used as input for a variety of algorithms for providing useful information to the presenter, audience members, or both, as will be appreciated by those skilled in the art after reviewing this disclosure.

The tablet devices, systems and methods of the present invention can incorporate wireless communications hardware and wireless protocol similar to that provided for the remotes 212, as will be appreciated by those skilled in the art after reviewing this disclosure. Some remotes 212 operable for use in a wireless audience response system 200 are described in U.S. patent application Ser. No. 11/155,080 (Pub. No. 20060286531) and U.S. patent application Ser. No. 11/748,687 (Pub. No. 20080096177), both of which are incorporated herein by reference in their entireties, including, without limitation, paragraphs [0021] through [0026] in US Patent Application Pub. No. 20060286531.

Referring again to FIG. 1, some embodiments of the present invention comprise a tablet 2, which can be a digitizing tablet having an input surface 4. A stylus or pointer 6 can also be provided, and the input surface 4 of the tablet 2 can detect a position of the pointer 6 with respect to the input surface 4 when pointer 6 is brought within proximity of the input surface 4, or touched against the input surface 4. Pointer position detection systems for use in digitizing tablets are widely available. For some tablets, sensing conductors are imbedded in an input surface of the tablet and when a radiating pen is placed on, or proximate, the surface of the tablet, signals are induced in segments of the sensing conductors to detect the position of the pointer. U.S. Pat. No. 4,878,553 and U.S. Pat. No. 4,661,656 disclose variations on such system for detecting the position of a pointer with respect to the surface of a tablet and are both incorporated herein by reference in their entireties. The pointer 6 can have one or more buttons 107 similar to mouse buttons, for use in selecting options as will be appreciated by those skilled in the art after reviewing this disclosure.

As shown in FIG. 1, input members, such as keys, can also be provided on the tablet 2, such as, for example, a multidirectional key 14 (e.g., 4-way rocker), a MENU key 16, a SEND key 18, a selection or ENTER key 20, a POWER key 22, and additional input keys 24, 26, etc., which may have assignable functions depending on user preference. In the illustrated embodiments, no alphanumeric keypad is provided, which can be accounted for by the use of templates, or assign functions or modes for locations for the input surface 4 (as described in further detail below).

The input surface 4 can comprise a substantial surface area of the tablet 2. In the illustrated embodiment, the input surface 4 is rectangular in shape, but can be different shapes in other embodiments. A cover 10 for the input surface 4 can also be provided. The material of construction for the cover 10 can be a transparent durable material, such as, for example, a clear plastic. In some embodiments of the present invention, the cover 10 can be removably coupled to the tablet 2 and a user can remove the cover 10 manually in order to replace or change templates, as discussed further below. Slide members 12 can be provided for operating a releasable lock (not illustrated in the figures), wherein when each slide member 12 can be manually pulled in a lateral direction (downward with respect to FIG. 1) to release the lock and allow the cover to be removed, as will be appreciated by those skilled in the art after reviewing this disclosure. In some embodiments, the lock can be spring loaded to bias the slide members 12 to a locked position when the slide members 12 are not manually pulled downward with respect to FIG. 1. In other embodiments of the present invention, the lock is not spring loaded, and the slide members 12 can be manually moved to slide a latch member to lock, or unlock, the cover 10, as will be appreciated by those skilled in the art after reviewing this disclosure.

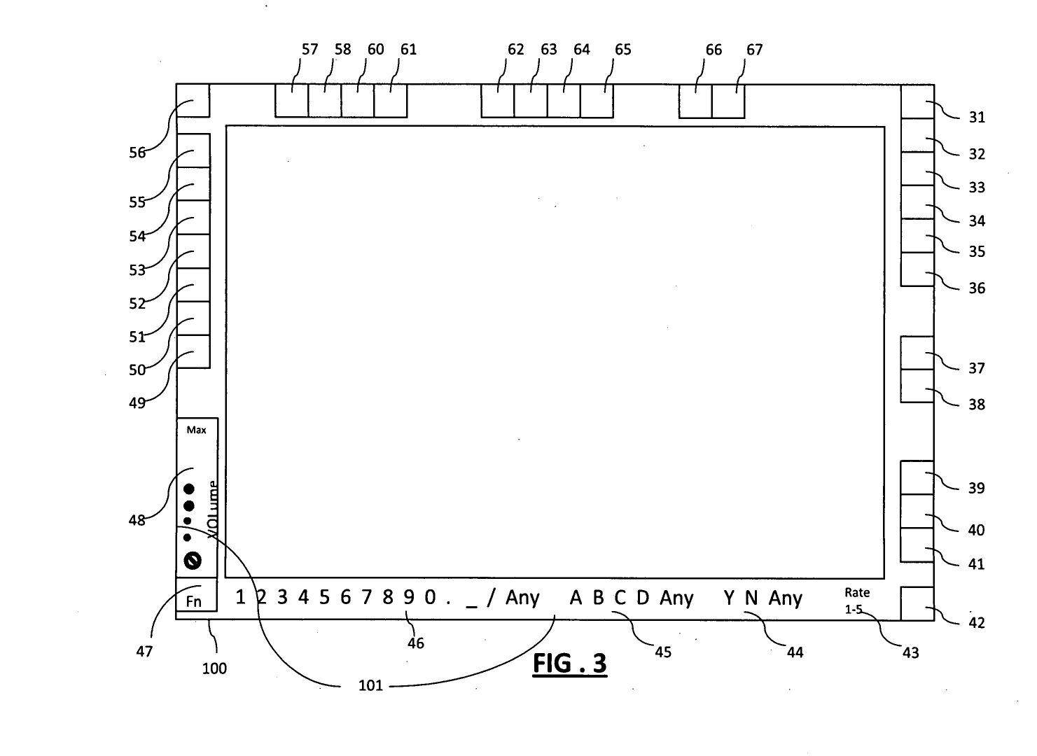

When the cover 10 is opened, or removed from coving the input surface 4, templates can be placed on the input surface 4. For example, as shown in FIG. 3, a first, or main template 100, is provided. The main template 100 can be made of paper or other thin flexible sheet material. The main template 100 can also have outer indicia marked thereon such as, for example, outer indicia 31-67. The indicia 31-67 are referred to and described throughout this description for illustrative purposes. However, the number of indicia, the associated functions and modes, and the locations of the outer indicia are not intended to be limiting unless the context states otherwise.

Referring to FIG. 1, the perimeter of the input surface 4 can comprise a raised edge 3, such that the input surface 4 is recessed, and the dimensions of the main template 100 shown in FIG. 3 can be configured such that when the main template 100 is placed on the input surface 4, the edges 101 of the main template 100 can fit snuggly against an inside wall of the raised edge 3. As such, the main template 100 is constructed to align in predictable position with respect to the input surface 4 and the positions of the outer indicia 31-67 can then be known with respect to the input surface 4 with a negligible degree of error for the purposes described herein. When the position of the pointer 6 is detected with respect to the input surface 4, the associated position detection signal can be used to determine whether a user is aligning the pointer 6 with any particular outer indicia 31-67 of the template 100.

Referring to FIGS. 1 & 3, in some embodiments of the present invention, position detection data is wirelessly transmitted from the tablet 2 to a computer 202 (such as a laptop computer). Layout information for template 100 regarding the locations of outer indicia can be provided to a memory of the computer 202 or tablet 2, usable by a processor of the computer 202 or tablet 2, in connection with coded instructions for comparing those locations against position detection data received at the tablet 2. Each outer indicia location for a particular template 100 can be associated with instructions executable by the computer 202. The instruction can include functions, or modes of operation, which can thus be activated when a user of the tablet 2 selects a corresponding outer indicia on the template 100 using the pointer 6, by, for example, laterally aligning a tip of the pointer 6 with a particular outer indicia within a predetermined vertical distance from the particular outer indicia (the vertical distance can be, for example, a particular height proximate the surface of the cover 10 above the template, as will be appreciated by those skilled in the art after reviewing this disclosure).

In some embodiments of the present invention, a display device 204 of the computer is provided, as well as a larger commonly viewable display device 205, or common display, such as a projection screen, for displaying images to an audience. In some embodiments of the present invention, a result of all or some of the functions or modes activated by selecting outer indicia 31-67 at the tablet will be reflected in one or more of the display devices 204, 205. For example, a user of the tablet 2 can select an outer indicia to cause graphical images such as text or objects to be displayed on the display devices.

The functions and modes of operation associated with outer indicia 31-67 in the illustrated embodiments on FIGS. 3 & 4 can be initiated by a processor of the computer 202, or by a processor in the tablet 2. In some embodiments, some of the functions or modes, associated with the outer indicia can be initiated at the computer 202 while others can be initiated at the tablet 2, as may be predetermined by software at the computer and firmware at the tablet 2. For example, when a user selects outer indicia 31, a processor on the tablet 2 can initiate a function to switch on a backlight to illuminate the tablet display 8 of the tablet. Also, when a user selects outer indicia 32, position detection data designating a location of outer indicia 32 can be transmitted to the computer 202 and, in turn, a processor of the computer 202 can initiate a mode to allow a user of the tablet to draw using the pointer 6, with the strokes of the pointer being graphically illustrated on a display 204, 205.

An example menu for functions and modes associated with outer indicia 31-67 for the main template 100 is illustrated in Table 1 below:

TABLE 1
Function/Mode Menu for Outer Indicia 31-67 for an
Embodiment of Main Template 100

| Outer Indicia # | Function or Mode if Outer Indicia Selected |
|---|---|
| 31 | Turns on backlight of the tablet display 8 to illuminate the display. |
| 32 | Activates a first pen mode, which allows a user of the tablet 2 to write |
| | or draw using a pointer 6 on the tablet 2, with the results graphically |
| | visible on a display 204, 205. |
| 33 | Activates a second pen mode, which allows the user to write or draw |
| | using a pointer 6 on the tablet 2, with the results graphically visible on |
| | a display 204, 205, in a different graphical format than that associated |
| | with outer indicia 32, such as, for example, a different color. |
| 34 | Activates a third drawing mode to allow a user to write or draw using |
| | the pointer on the tablet 2, with the results visible on the display 204, |
| | 205 as a straight line, arrows, dotted lines, or other graphical variation. |
| | In some embodiments, the selection of the particular graphical format |
| | associated with this outer indicia can be made at the computer 202. |
| 35 | Activates a keyboard mode for use with keyboard overlay template 102 |
| | (as discussed in further detail below). |
| 36 | Allows a user to select media (e.g., sound, graphics, animation or a |
| | combination thereof) to be presented via computer 202 and display |
| | 204, 205. The media can be selectably pre-associated with outer |
| | indicia 36. In some embodiments, selecting this outer indicia can cause |
| | a file selection application, such as a file browser application, on |
| | computer 202 to open and be displayed on display 204 or 205. In other |
| | embodiments, the file selection menu can appear on tablet display 8. |
| 37 | Instructs computer 202 to allow a user to hide a first graphical image |
| | on the display 204, 205 by imposing a second graphical image over a |
| | display area occupied by the first graphical image. The user can then |
| | reveal or conceal the first graphical image using a “drag” function |
| | whereby the user can retract or extend a length of the second graphical |
| | image on the display to display all, or a portion of, the first graphical |
| | image. In addition, in some embodiments, the entire second graphical |
| | image can be removed by selecting a particular input member, such as |
| | a particular pre-assigned indicia. “Dragging” to retract or extend the |
| | second graphical image can produce a “window shade” effect to reveal |
| | or obscure the first graphical image. |
| 38 | Instructs computer 202 to display a graphical dot-like image on display |
| | 204, 205 corresponding to a position of the pointer 6 on the input |
| | surface 4 when the pointer 6 is proximate the input surface. This can be |
| | displayed as a red colored dot simulating a “laser pointer” on |
| | commonly viewable display 205. |
| 39 | Instructs computer 202 to operate in a first pointer mode corresponding |
| | to a “cursor” control mode which maps the cursor position on a display |
| | 204, 205 to a position of the pointer 6 on a live area on the input |
| | surface 4. When the pointer 6 position is detected with respect to the |
| | templates, or portion thereof, the position of a cursor is proportionally |
| | represented on the graphical area on display 204, 205. |
| 40 | Instructs computer 202 to operate in a second pointer mode, |
| | corresponding to a “mouse” mode, wherein position detection |
| | information received from the tablet 2 for pointer 6 is tracked for |
| | movement to proportionally move a cursor from a last static position on |
| | display 204, 205, and wherein when the pointer 6 position is not |
| | detected, the cursor position remains static with respect to display 204, |
| | 205. |
| 41 | Instructs computer 202 to display a graphical keyboard on display 204, |
| | 205 for use in typing or selecting keys with pointer 6. |
| 42 | Instructs the computer 202 or tablet 2 to lock-out functions or modes |
| | that can be activated by selecting the outer indicia 31-67. This lock-out |
| | option can be useful in preventing accidental selections. |
| 43-46 | Each outer indicia 43-46 can be associated with an inquiry format. For |
| | example, if a presenter selects outer indicia 44, the audience response |
| | system 200 can be placed in a mode such that audience members can |
| | only select to transmit responses corresponding to “YES” or “NO” by |
| | using corresponding keys on remotes 212. In some embodiments, |
| | audience members are in possession of an embodiment of the tablet 2 |
| | and can use YES or NO indicia 44 to send responses to such inquiries. |
| | If a presenter selects outer indicia 44 on tablet 2, in some embodiments, |
| | a graphical image can be presented to audience members which |
| | prompts audience members to respond in the expected format (e.g., |
| | YES or NO). These are examples only, not intended to be limiting. In |
| | some embodiments, and in some modes, when a presenter selects one |
| | of the indicia 43-46, a corresponding spontaneous question can be |
| | posed. For example, if a presenter selects one of the letter indicia 45, |
| | say “B,” for example, the computer 202 is instructed to store a |
| | multiple-choice question associated with a question identifier with the |
| | letter “B” as a corresponding correct answer. The tablet display 8 can |
| | privately indicate to the presenter that a spontaneous question mode has |
| | been selected, in multiple-choice letter format, and that the answer will |
| | be letter choice “B.” The presenter can confirm the data by selecting |
| | an input key (e.g., one of keys 14-26 on the tablet 2 or a pre-assigned |
| | outer indicia). The presenter can then verbally ask the question and |
| | cause optional answer choices to be displayed on display 204, 205, |
| | with the correct answer choice being associated with the letter “B.” |
| | The audience response system 200 can receive responses to be stored in |
| | association with the particular question posed, for use in current, or |
| | future, comparison against the stored answer choice. In other |
| | embodiments, the presenter can write the question using pointer 6 on |
| | the tablet 2, type the question using a keyboard overlay (as discussed |
| | further below) or select other pre-programmed graphical medium to |
| | present the question and optional answer choices on display 204, 205. |
| 47 | Toggles the audience response system 200 between master modes. In a |
| | first master mode an entire inner area, or live area, within a perimeter, |
| | such as a perimeter defined by the inner edges of outer indicia 31-67, |
| | can be operable for use in writing, cursor control, pointing, or drawing, |
| | depending on which sub-modes are active, such as, for example, those |
| | associated with indicia 32-34, 38-40, 49. In a second master mode, the |
| | inner area, or live area, is divided in accordance with active templates, |
| | such that different sections can be used to perform different actions or |
| | initiate different functions or modes (as described further below). |
| | Other manners for “toggling” between modes are described below, |
| | which may be provided in some embodiments of the tablet 2, in |
| | addition to the toggling function associated with indicia 47. |
| 48 | Controls volume of audio played over speakers (not illustrated) |
| | associated with the audience response system. |
| 49 | Initiates a pointer 6 function to delete graphical objects, or portions |
| | thereof, as may be selected using the pointer 6. The objects can be |
| | selected by pointing at the object using the pointer 7 in a cursor mode, |
| | and selecting button 107 on the pointer, or by pointing at the object in |
| | other embodiments. |
| 50 | Causes a graphical object to be pasted at a location using pointer 6 |
| | (e.g., such as by pointing at the corresponding location on the input |
| | surface with the pointer 6 and clicking button 107). |
| 51 | Causes a graphical object selected by using pointer 6 to be copied and |
| | stored for later use. |
| 52 | Causes a menu to be displayed on the tablet display 8 for use in |
| | selecting a file from a list of frequently used software application files, |
| | media presentation files, graphical object files, or other type of |
| | commonly used file, to be run or opened on the computer 202, and |
| | which can be displayed on the display 204, 205. The most frequently |
| | used files can be historically logged for a given period of time, and can |
| | include up to ten (10) files in some embodiments of the present |
| | invention. In other embodiments, more than ten or less then ten files |
| | can be included in the list. A user can scroll through the list of file |
| | names using an input key of the tablet, or other indicia on a template of |
| | the tablet which may be pre-programmed for use in scrolling through |
| | the list on tablet display 8. |
| 53 | Causes an internet browser to open on computer 202 and be displayed |
| | on display 204, 205, or, in the alternative, causes a pre-programmed list |
| | of alternative website names to be viewable in display 8 of the tablet 2 |
| | through which a user can scroll (discussed in further detail below). |
| 54 | Causes a particular file, or set of files to be displayed by file name on |
| | tablet display 8. At least some of the files can be pre-set by a user to be |
| | associated with indicia 54, such that when indicia 54 is selected, a list |
| | of pre-designated files can be shown in tablet display 8 for quick view |
| | and selection by a user of the tablet 2 (discussed in further detail |
| | below). |
| 55 | Creates a new slide, or new graphical image, or new file or document, |
| | depending on a selected live application on computer 202. |
| 56 | Launches a software application on computer 202, which can be used |
| | in connection with the tablet 2, for providing a primary application |
| | interface for use on computer 202 when the audience response system |
| | 200 is live or when the tablet 2 is in communication with computer |
| | 202. |
| 57 | Play or pause audio, video, animation or multi-media files or |
| | presentations. |
| 58 | Picks an audience member, such as by executing an algorithm to name |
| | an audience member for responding to an inquiry. |
| 60 | Opens a dialogue box on display 204, 205, or within display 8, the |
| | configuration of the dialogue box being pre-defined in association with |
| | an application mode being run on computer 202. For example, if the |
| | tablet 2 is being used in connection with a slide presentation run on |
| | computer 202, a dialogue box (and character or graphics displayed |
| | therein) opened by selecting indicia 60 can be dependent on, and a |
| | function of, the current slide or current presentation. |
| 61 | Instructs tablet 2 to display a list of persons who have transmitted |
| | private help messages in the audience response system 200. The |
| | persons transmitting help messages can be identified by the audience |
| | response system 200 via the transmission of pre-associated remote 212 |
| | identification codes to the central computer 202, as will be appreciated |
| | by those skilled in the art after reviewing this disclosure. The help |
| | message and student identification are then, in turn, transmitted to the |
| | tablet 2 via the wireless protocol associated with the audience response |
| | system 200. The persons on the list can be removed from the help |
| | queue one at a time as the presenter addresses each particular help |
| | request, or all at once after the presenter addresses all help requested. |
| | For example, when deleting help requests one at a time, the presenter |
| | can have a private discussion with a person requesting help, then the |
| | presenter can select the person from the list, and select to delete the |
| | person from the list using an input key on the tablet 2. |
| 62 | During a presentation, causes a new slide to be inserted in the |
| | presentation. The new slide can be associated with an inquiry. The |
| | new slide is displayable along with an inquiry posed by the presenter. |
| | An answer key, or answer, to be stored on a memory of the computer |
| | 202 in association with the inquiry can be provided privately to the |
| | presenter on the tablet display 8 of the tablet 2, at the time of presenting |
| | the new inquiry. That is, in some embodiments of the present |
| | invention, after providing the new and/or spontaneous inquiry, the |
| | presenter can select to store an associated answer by again selecting |
| | indicia 62 to place the tablet 2 in an answer key receiving mode, and |
| | thereafter selecting or typing the answer using a keyboard template 102 |
| | or other indicia on template 100. In the answer key receiving mode, |
| | the tablet 2 can display a visual verification of the selected answer on |
| | tablet display 8, whereupon, a user can then select to store the answer |
| | by again selecting indicia 62. |
| 63 | Provides additional time for an audience to answer an inquiry when the |
| | inquiry is timed. Selecting the indicia 63 can add a pre-set increment |
| | of time, such as, for example, 15 seconds, or more or less than 15 |
| | second. |
| 64 | Stops the audience response system 200 from accepting answers to a |
| | particular inquiry posed, such that a presenter can cut short a time |
| | period for response to an inquiry, or can stop the audience response |
| | system 200 from accepting responses if no timer is applied to a |
| | particular inquiry. |
| 65 | Initiates a response collection mode in which the audience response |
| | system 200 is operable to receive responses from audience held |
| | remotes 212. In some embodiments, for some inquiries, an associated |
| | timer is initiated at computer 202 for gauging a time for response or for |
| | terminating the response collection period at a particular time. |
| 66 | Causes audience response data to be displayed on tablet display 8 in |
| | relation to one or more inquiries, wherein the audience data can be |
| | displayed in a graphical format, such as, for example, a bar graph |
| | showing the number of audience members who selected the correct |
| | answer, or who selected each answer choice in a multiple choice |
| | inquiry, or who selected YES, and each who selected NO, in a |
| | YES/NO inquiry, etc. In some embodiments, a presenter can see |
| | additional information regarding the data by, for example, selecting to |
| | view a list of audience members, such as students, who have answered |
| | an inquiry correctly, or incorrectly, or those who have failed to answer. |
| 67 | Causes audience response data to be displayed on display 205 to be |
| | viewable by audience members. The audience response data can be |
| | displayed in a pre-programmed or pre-selected format. |

In some embodiments of the present invention, the tablet display 8, or LCD, on the tablet 2 can be compact. For the tablet 2 illustrated in FIG. 1, the tablet display 8 dimensions may be, for example, without limitation, approximately 120 pixels by 64 pixels, or approximately one and one half (1½) inches in width and three quarters (¾) of an inch in height. Other larger tablet display 8 dimensions are contemplated; however, compact dimensions, such as 120 pixels by 64 pixels, can contribute to portability of the tablet 2 as well as cost efficiency. Nonetheless, it can be difficult to navigate though a conventional menu system using a compact tablet display 8 for the purpose of selecting files using the tablet 2 because of the limited size of the display.

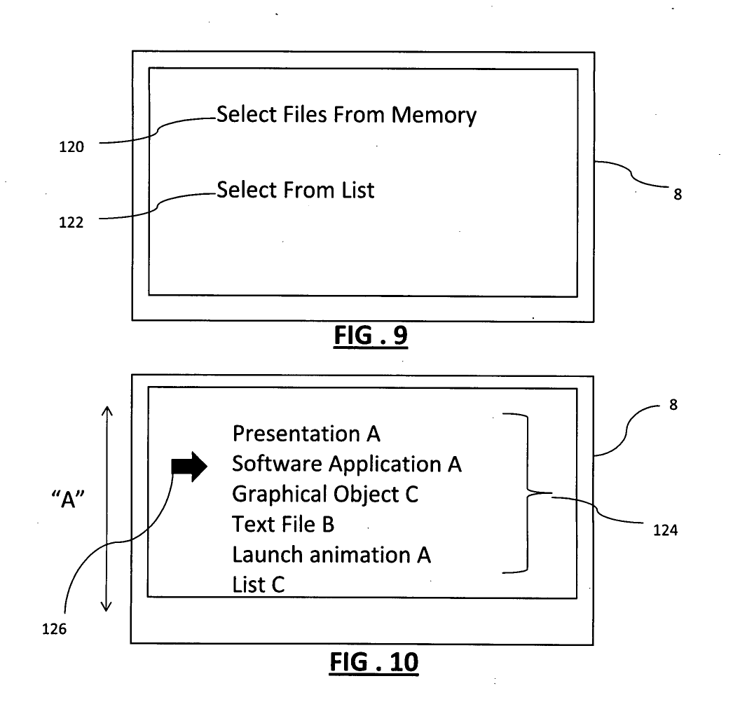

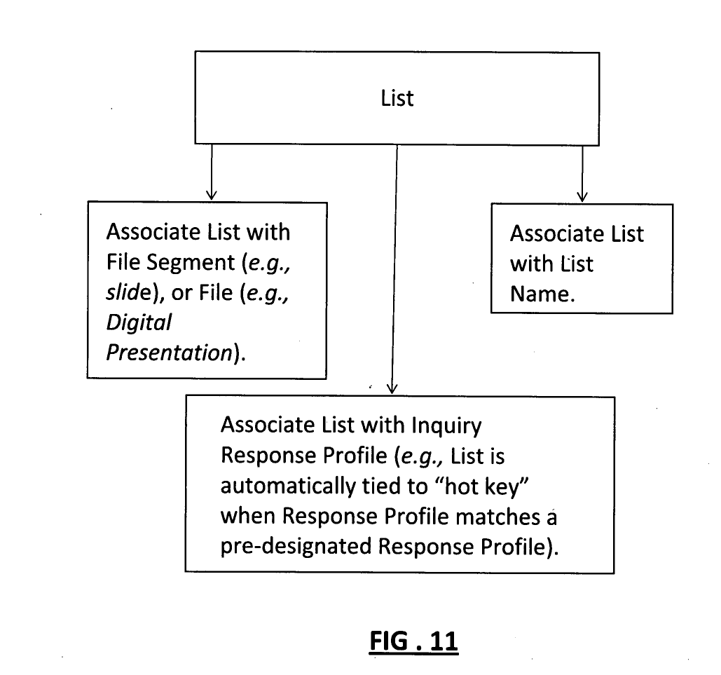

Referring to FIG. 9, in some embodiments, when outer indicia 54 is selected, tablet display 8 can display both a first selectable option 120 which can be selected to view a file browser menu for browsing files in a memory of computer 202, and a second selectable option 122 selectable to display a list of files, other lists, functions for the tablet, or modes for the tablet, or combinations thereof, on tablet display 8 through which a user can scroll and select as desired. The list of files, lists or functions or modes associated with the second option can be a pre-set list. In some embodiments, the list can include file names 124, icons, other file identifiers, lists, functions or modes which the user has designated ahead of time for use with a particular presentation or activity. See, e.g., FIG. 10. A user can scroll through the list 124 in the directions of arrow “A,” by moving a cursor 126, using, for example, an input key on the tablet 2. In other embodiments, indicia are provided on a template for use with the pointer 6 for controlling the cursor 126. In either case, when a user has selected a desired file, list, function (which can include an activity) or mode shown on tablet display 8 using cursor 126, the user can select the item using an input key or indicia. Thereafter, the tablet 2 can transmit a corresponding identifier to computer 202 to initiate an action at the computer 202 to open or run the selected item. In some embodiments, the ability to see additional lists, such as, for example, the list labeled as List C in FIG. 10, which can be associated with an initially selected list or a higher level list, allow a user to locate sub-lists and the sub-lists themselves can be associated with files, other sub-lists, functions or modes.

In some embodiments, one or more lists 124 can be created using an application provided at computer 202 and a user can initiate an instruction to transmit the lists to the tablet 2 upon request from a user initiated at the tablet 2.

In some embodiments of the present invention, multiple lists of files or sub-lists can be pre-set and stored on a memory of tablet 2, a memory of computer 202 for access by the tablet 2, or both, and each list can be stored to be triggered in association with (a) a file (e.g., digital presentation file) or file segment (e.g., slide in a digital presentation), (b) a designated response profile for a designated inquiry, or (c) a list name, as shown in the association diagram in FIG. 11. For example, with respect to associating a list with a file (or file segment), a plurality of lists can be created, with each list being immediately displayable on tablet display 8 by use of a designated “hot key” on the tablet 2, or being displayable automatically, depending on a current activity. For example, the list tied to the hot key, or displayed automatically, can be different for different presentations, or for different slides within a presentation, or can be the same for some slides with one or more particular slides having an associated modified list. The computer 202 can be provided with coded instructions to allow a user to create such plurality of lists of files and associate each list with presentations, slides, or other activities executable in conjunction with the computer 202. As such, during a particular presentation, or slide, when a user of the tablet 2 presses a designated “hot key,” which can be one of the input keys of the tablet 2, the particular associated list is displayed on tablet display 8 through which a user can scroll to select an item. The items can be any type, such as those described previously, and can contain any content which the presenter or user feels might be helpful during the presentation, or an aspect of the presentation.

With respect to the association of lists with designated response profiles for an inquiry, in some embodiments, the list currently tied to a hot key on the tablet 2 can be a function of responses collected in the audience response system 200, as exemplified below in PROPHETIC EXAMPLE #1. In general, lists of items can be associated with inquiries, and whether the lists are called up on tablet display 8 by a designated hot key can be a function of response profile to the inquiries.

With respect to the association of lists with list names, in some embodiments, a plurality of list names can each be associated with a list, and the plurality of list names can be viewed on tablet display 8 by a user actuating a designated input key or indicia (not illustrated). The user can then scroll through the list names, in a manner similar to scrolling through a list as described above in connection with FIG. 10, and once the user of the tablet 2 selects a list name, the selected list can be displayable in tablet display 8, so that a user can scroll through the list to select an individual file to run or open. The selection of a file using the list names and lists can be conveniently undertaken on tablet 2, from a location remote from compute 202, using only tablet display 8.

### Prophetic Example #1

A teacher (user) has created, using computer 202, a plurality of lists, associated with different slides in a presentation regarding physics. The lists are stored in a memory of the computer 202. The teacher has also used the application on computer 202 to associate certain ones of the lists with certain slides of the presentation. In addition, a default list is designated. Furthermore, the teacher has designated certain ones of the lists to be associated with particular response profiles to inquiries in the presentation.

During the presentation, the default list is tied to a hot key on the tablet 2 a majority of the time, such that when the hot key is pressed, the default list of files is shown on tablet display 8 of the tablet 2, so that the teacher can scroll through the list of files to select a file to run or open on computer 202, or to be displayed to the students on display 205. The hot key can be one of the input keys 18-26 of tablet 2 in some embodiments of the present invention. For other parts of the presentation, the hot key is automatically associated to certain lists tied to particular slides being presented. In one instance, the teacher presents a slide showing an equation for calculating “work.” A student has asked a particular question regarding how “work” is related to “force,” and the teacher presses the hot key. A unique list has been associated with the currently active slide, and a list of files regarding the relationship between force and work is displayed on tablet display 8, with some of the files being additional slides having graphical images for explaining the physical relationship. The teacher scrolls through the files and selects a slide title to open a slide showing a simple graphical example of how the area underneath the curve in a force vs. distance plot, equals work.

The teacher then poses a multiple choice inquiry to the class, asking them to calculate “work” given a fact pattern. The responses are collected at computer 202 within audience response system 200 as the students respond using remotes 212. A processor at computer 202 then executes a preprogrammed instruction to count the number of incorrect answers and determine if the number exceeds 20% of the class present, and if so, to transmit a particular list to tablet 2 to be associated with the hot key. The teacher then selects indicia 66 and notes that a majority of students have answered incorrectly. The teacher then selects the hot key and sees the list that has just been tied to the hot key as a function of the response profile. The list includes a variety of files that can be used by the teacher to go through examples of calculating “work” using integrals. The teacher later advances the presentation to a next slide and the hot key is again automatically tied to the default list of files.

The teacher then reaches the end of the presentation regarding physics and time is still left in the class period. The teacher actuates the hot key. The tablet display 8 then displays a plurality of list names, which the teacher has pre-programmed on computer 202. The list names include, for example, a name relating to class schedule files. The teacher selects that list name and a new list is presented for display on tablet display 8. The teacher scrolls through the list and selects a file named “test schedule for period 1.” The teacher selects the file to be opened on display 205 and discusses the test schedule with the students as the schedule is displayed to them.

As will be appreciated by those skilled in the art after reviewing this disclosure, the forgoing example is not intended to be limiting. For example, in some embodiments, the lists not only represent file names, but can also include identifiers for slides in a current presentation, or a list of students that have answered the most recent inquiry incorrectly, etc. Again, such lists can be defined in a plethora of manners and flexibility for navigating through the lists is provided by associating the lists with list names, so that a user can navigate through the list names as explained above, or by tying the lists to hot keys depending on a current activity or result of the activity.

In some embodiments of the present invention, a plurality of interchangeable, or simultaneously usable, templates can be provided for each tablet 2. The templates can each be associated with a pre-assigned unique ID which can be stored on a memory of the computer 202 in association with layout information of the template so that a processor of computer 202 can compare live position detection data against layout information associated with the particular template.

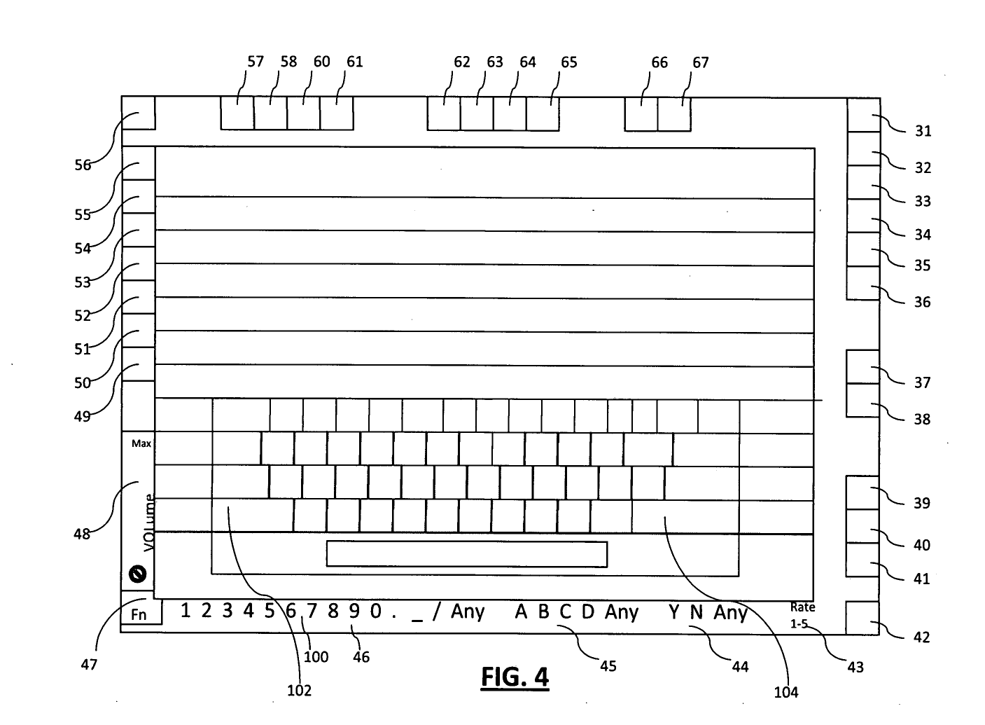

In some embodiments, all users have at least two templates in common, each associated with an ID. One of the common templates can be a main template 100, having outer indicia 31-67 for use in marking locations on the input surface that are associated with particular modes or functions, as shown in FIG. 4 and described above in Table 1. Another common template can be a keyboard template 102, such as illustrated in FIG. 4. The keyboard template 102 and the main template 100 can be default templates in some embodiments of the present invention. That is, for example, main template 100 and keyboard template 102 are provided to users of the tablet 2, along with software for computer 202 that is configured to initially define templates 100 & 102 as loaded templates, ready for activation at tablet 2 when the tablet 2 and related system is live.

In some embodiments, a user of the tablet 2 can use input keys, or indicia, and tablet display 8 to enter a template ID to be transmitted to computer 202 to load any particular template for use with the tablet 2, provided that the layout information for the particular template has previously been provided to the computer 202. Templates can also be selected to be loaded in other manners, such as, for example, by use of a graphical menu system displayable on monitor 204 of the computer 202, on which a user can enter a template ID, or select from a list of pre-stored templates, as will be appreciated by those skilled in the art after reviewing this disclosure. Once loaded (e.g., loaded into a registry), the template can be activated at the tablet 2 by a user selection, as described previously.

In some embodiments of the present invention, a keyboard template 102 made of transparent sheet material can be provided as shown in FIG. 4. The keyboard template 102 can include a printed keyboard image 104 having conventional alphanumeric and symbol keys represented at particular locations on the template 102. The dimensions of the keyboard template 102 can be the same as the dimensions of main template 100, and can be placed as an overlay template directly over the main template 100, and secured in place by cover 10. The keyboard template 102 does not completely obscure an underlying template because of its transparency. Also, the raised edge 3 of the tablet 2 can rise high enough above the input surface 4 to accommodate several template overlays, like the keyboard template 102.

Layout information for the keyboard template 102 can be stored in a memory of the computer 202 along with coded instruction for associating each key location with a particular function or mode. A user can select to activate the keyboard template 102 at computer 202 by providing the ID of the template 102 to the computer 202, or by otherwise selecting the keyboard template 102 from a menu displayable on display 204 of the computer 202. Thereafter, a user of the tablet 2 can selectively activate the keyboard template 102 at the tablet 2 by, for example, selecting indicia 41, or by inserting a cursor in a current text object on a display 204, 205, or de-activate the keyboard template 102 by clicking outside a text object, selecting a different mode on outer indicia, or choosing a new tool. As will be appreciated by those skilled in the art upon reviewing this disclosure, when the keyboard template 102 is activated, the pointer 6 can be used in connection with the keyboard template 102 to perform substantially all functions of a conventional keyboard, including, without limitation, typing letters and numbers.

In the illustrated embodiment of the keyboard template 102 in FIG. 4, neither the keyboard image 104, nor the transparent template 102, obscures the outer indicia 31-67. This can allow both the main template 100 and keyboard template 102 to be simultaneously active for use. In other embodiments template 100 and keyboard template 102 could be contained in a single template with keyboard mode being triggered through simply selecting indicia 41.

In some embodiments of the present invention, the main template 100 is secured to the input surface 4 below other templates, such as a keyboard template 102 as described immediately above. In other embodiments of the present invention, the main template 100 is made of transparent flexible sheet material, and can be secured to the tablet 2 above, or over, one or more other templates. In such embodiments, since the main template 100 is transparent, one or more templates positioned beneath the main template can be visible, in whole, or in part, through the main template. This allows use of the main template 100 in connection with other templates that may be printed on opaque material. Furthermore, the keyboard template 102 can also be transparent as describe above, so that yet another template can be secured to the tablet 2 below the keyboard template 102.

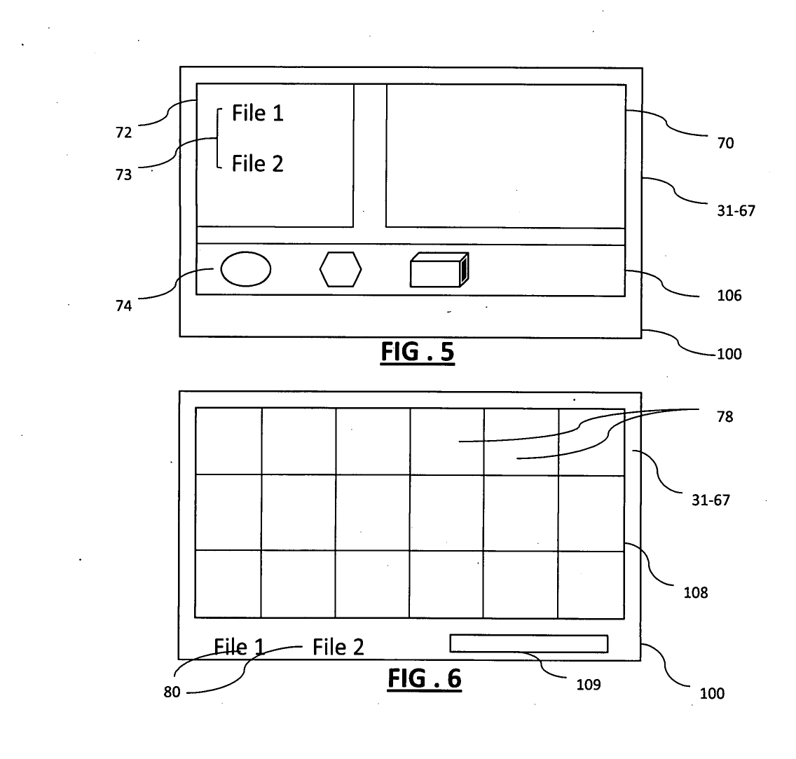

In further embodiments of the present invention, additional interchangeable templates are provided. FIG. 5 shows a template 106 placed beneath a transparent main template 100. The template 106 can have a first image area 70 which can be used for printing a user selected image. Computer 202 can be provided with coded instruction for allowing a user to create a variety of templates, with some templates having one or more image areas, such as image area 70. During creation of the image templates, a graphical image of the image template can be displayed on a monitor 204 of computer 202. In some embodiments, a user can select a screen capture of another graphical image, such as, for example, without limitation, a presentation slide containing one or more objects and text, to be displayed within an image area, such as image area 70. The selected graphical image can be automatically or manually adjusted in size to best fit, or approximately fit, the image area 70. The image area 70 itself can be mapped to a display device 204, 205. In the illustrated example, template 106 can be printed on opaque material, such as printer paper, with outer edge of template 106 also being printed and sized to match the outer edge dimensions of main template 100, and with an image selected by a user also being printed within the image area 70. In some embodiments of the present invention, a user can use a cutting tool to cut the printed paper along the edges of printed template 106 to finalize the template for use as on the input surface 4 of the tablet 2. In some embodiments, crop marks are printed on the paper along the printed template 106 to help define the perimeter of the template, which is configured to fit over input surface 4.

Similar to the keyboard template 102 discussed previously, the layout information for template 106 can be stored in a memory of computer 202 and the template 106 can be selectively activated by a user of the tablet 2. Template 106 and main template 100 can be simultaneously activated for use in selecting functions and modes and for annotating. In some embodiments, the outer indicia can also be printed on template 106 directly, which may be the case if the outer indicia 31-67 are changed by a user. In such case, the new outer indicia can be printed on template 106.

In some embodiments, if template 106 is active, only the image area 70 is a live area (i.e., drawing area, or area in which the movement of the pointer 6 with respect to the area 70 is displayed on display 204, 205) of the template 106, which is mapped to an image electronically shown on display 204, 205. Other areas 72, 74 of the template 106 can have discrete locations that can be selected with pointer 6 to active associated functions or modes. A user can, for example, annotate on an image shown on the display 204, 205 by drawing on the tablet over area 70 using the pointer 6 in a pen mode associated with indicia 32. Although the image printed in the image area 70 on template 106 is static, it can be convenient for a user of the tablet 2 to execute at least short annotation activities by looking only at the image printed on image area 70 on the tablet 2, without having to look up at a display 205, on which the same image is also electronically displayed.

In some embodiments of the present invention, the computer 202 is also provide with coded instructions to allow a user creating a template to assign functions or modes to specific predefined locations on the template, in addition to those associated with outer indicia. For example, in creating template 106, a user could associate a plurality of files to specific locations within area 72 and those locations could be associated with instructions to open the corresponding files for display to audience members. In the illustrated embodiment in FIG. 5, a list 73 of files names (or file indicia) is printed within area 72 of template 106, and when template 106 is active, a user can open a file by selecting corresponding file indicia in area 72 using pointer 6. As such, a convenient method is provided for a user to plan a presentation or program, with a list of possibly relevant files being pre-printed on template 106 for use on tablet 2 in connection with other functions and modes available for selection on the tablet 2.

In yet further embodiments of the present invention, an object selection area 74 is provided within template 106. While creating the template 106 on computer 202, a user can select graphical objects to be prepared for use in selectably dragging the object onto a graphical image (such as a presentation slide) shown on display 204, 205. Images of the objects can be captured and displayed in area 74 as represented during creation of the template 106 on a monitor of a computer 202. The objects can be stored in memory of the computer 202 in association with the template 106 layout information. The locations of the objects on template 106 can also be stored with layout information for the template 106. Thus, when the template 106 is printed and then positioned over input surface 4, a user can select an object printed within area 74 using pointer 6, and drag that pointer 6 across the input surface to live area 70, whereby a graphical image of the object is displayable on display 204, 205. In some embodiments, the object is “dropped” at a location on the display 205 that is mapped to a location on the live area 70 where a user lifts the pointer 6 from the input surface 4, as will be appreciated by those skilled in the art after reviewing this disclosure.

In further embodiments of the present invention, a user can provide list names, or descriptions of lists, on the printed template, such as template 106. The locations on which the list names, or list descriptions, appear can be stored as part of the template layout information. When the pointer 6 position is detected to be selecting one of the list names or descriptions, the corresponding list can appear in tablet display 8.

Referring to FIGS. 6 & 7, in another embodiment of the present invention, coded instruction is stored on a memory of computer 202 for enabling a user to create a slide sorter template 108. The user can associate the template 108 with a slide presentation.

Thumbnail images of each slide in the slide presentation can be assigned to a location 78 on template 108. The thumbnail images can be printed with the template 108, in the assigned locations 78. The layout information of template 108 associates each thumbnail location with a particular slide of the presentation, such that when the presentation file is open on computer 202, a user can select slides by touching corresponding locations on the template 108 using pointer 6. Thus, a convenient and quick method and system for selecting slides during a presentation is provided by the present invention.

Furthermore, in some embodiments of the present invention, no thumbnail images are printed on template 108, but the assigned locations 78 are blank and can still be selected using pointer 6 to navigate between slides of a presentation. See, FIG. 6. For example, a user can slide the pointer across the different assigned locations 78 to scroll through a slide presentation, or can skip slides by tapping the pointer on a slide at a latter location on the grid of assigned locations 78, as will be appreciated by those skilled in the art after reviewing this disclosure. Furthermore, presentation file names can be printed on template 108 and those particular locations on the template 108 can each be associated with a presentation file. As such, a user can also select different presentations to be displayed on display devices 204, 205 using the tablet 2, and then scroll through associated slides using pointer 6.

In some embodiments of the present invention, template 108, or another template, has a line or bar 109 which can define a location on the input surface 4 over which a user can drag the pointer to scroll through slides in a slide presentation. In the illustrated example shown in FIG. 6, sliding the pointer right along the length of bar 109 can scroll forward in a presentation, and sliding the pointer left can scroll backward in a presentation.

The bar 109 can be used to scroll quickly through a presentation, and the grid 78 can be used to make fine adjustments to the slide displayed. In other embodiments, only the bar 109 or only the grid of locations 78 are available on a given particular template for use in selecting slides.

In some embodiments, when a user slides the pointer across indicia on a template to scroll through slides, the tablet display 8 can be automatically placed in a mode to display a slide number, or page number, of a slide being scrolled to, prior to displaying the slide on a commonly viewable display 205. Once a presenter has scrolled to a desired slide number or page number on the private tablet display 8, the presenter can select to display the slide on the common display 205, by actuating one of the input keys, or by selecting other indicia on a template.

Thus, in general, it is noted from the illustrative examples provided above, that for some embodiments, when some indicia on templates is activated using pointer 6, information can be provided on tablet display 8, privately to the user of tablet 2, in the process of using or selecting the function or mode associated with the particular indicia. The privately displayed information can aid in the execution of the function or mode without displaying the information to audience members while a result of executing the function or mode can be displayed to audience members on a common display 205.

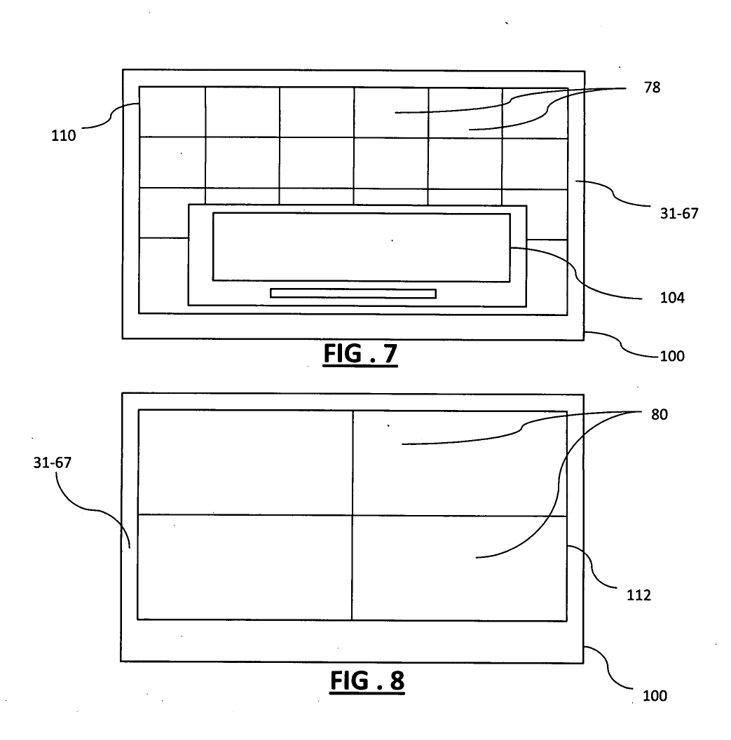

As shown in FIG. 7, in some embodiments of the present invention, a slide sorter template 110 is provided, which can be combined with a printed keyboard image 104. The slide sorter template 110 can be secured to the tablet 2 input surface 4 under the main template 100 (if the main template is transparent), or over the main template (if the slide sorter template 110 is transparent). The printed keyboard image 104 can also be part of another template, such as template 102. Each of the templates, including the main template 100, can all be simultaneously loaded and ready to activate for use on tablet 2.

Referring to FIG. 8, in some embodiments of the present invention, a template 112 can be provided having multiple separate live areas 80 for use in live annotation or pointing, wherein each separate live area 80 can be individually mapped to a graphical image displayable on display 204, 205. A user can select graphical images (e.g., slides) to be presented on display 204, 205 by selecting a toggling indicia (not shown) on a main template 100. As a particular graphical image is shown, the user can apply the pointer 6 on the appropriate live area 80 having a corresponding printed picture for annotation purposes. In other embodiments of the present invention, when the pointer 6 is detected at one of the live areas 80, a graphical image which has been pre-associated with the particular live area 80 is automatically displayed on display 204, 205, whereupon a user can annotate the graphical image using pointer 6 within the corresponding live area 80. In some embodiments, when tablet 2 is in a mode wherein one of the live areas 80 is active and mapped to an image on display 205, a user can spontaneously select indicia 47 to activate the entire input surface 4 (within outer indicia 31-67) instead as a live area mapped to the image on the display 204, 205.

In further embodiments of the present invention, coded instructions are provided for the computer 202 for use in carrying out the creation of templates, and the association of template layout information with specific modes, functions, and mapped areas. For example, a computer readable medium (e.g., floppy disks, CD-ROM disks, tapes, flash memory, system memory, DVD-ROM, or hard drives) can have such coded instructions readable by a processor of a computer 202.

In other embodiments of the present invention, computer readable mediums are provided containing template layout information dedicated to pre-printed templates which can be distributed in association with the computer readable medium. For example, in one embodiment, a text book publisher provides templates for one or more chapters of a book, with the templates being printed with unique function or mode indicia, which can be convenient for practicing lessons within an associated text book, or chapter thereof. For example, in a math text book, a publisher can publish a template having a plurality of mathematical functions printed on indicia (e.g., “derivative,” “integral,” etc). Coded instructions providing template layout information for the tablet, and algorithms to be executed when the particular indicia are selected are provided on a computer readable medium (e.g., flash drive) or downloadable through an online website of the publisher, for storage on a memory of computer 202 to be executed by a processor of the computer 202.

In some embodiment of the present invention, certain indicia on a template can be pre-designated by a user to trigger particular functions or modes depending on an active application. Some of the indicia 31-67 on main, or first, template 100, can be set to activate functions or modes depending on whether an application is presently running at computer 202. For example, while preparing for a presentation, a user can use computer 202 to associate indicia 31 on main template 100, with an application, such as, for example, a spread sheet application or a presentation software, and then associate indicia 31 with a particular function or mode. Thereafter, if a user of the tablet 2 activates the particular application with which the indicia 31 has been associated, the associated function or mode is active and is triggered when the user points to indicia 31. In this manner, different functions or modes can be triggered by different indicia, depending on an application that is active.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices, systems and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A tablet system comprising:
a tablet having an input surface;
a pointer;
a plurality of sensing members for detecting a position of the pointer proximate the input surface and for generating position detection signals;
a processor operable for receiving position detection data from the tablet based on the position detection signals and for comparing the position detection data against layout information for the input surface, the layout information including location information related to indicia that are selectable for initiating at least one of a function and mode of the tablet system; and
wherein at least one of the locations of indicia can be selectively mapped to a location displayable on a display device.

2. The tablet system of claim 1 wherein when the at least one of the locations is mapped to a location on the display device, a user can annotate an image displayed on the display device when pointing the pointer at the at least one of the locations.

3. The tablet system of claim 2 further comprising a template sheet attachable to the input surface having at least one printed image printed thereon, wherein a likeness of the printed image is displayable on the display device, and wherein when the at least one of the locations is mapped to a location on the display device, the at least one of the locations is aligned with a corresponding location on the printed imaged.

4. The tablet system of claim 3 wherein the template sheet can be created by a user and the layout information of the template sheet can be supplied to the processor for identifying the location of indicia or locations on the printed image.

5. The tablet system of claim 1 wherein a plurality of different template sheets can be provided for use with the tablet system, each template sheet having different layout information, and wherein the layout information for each template sheet can be supplied to the processor for selective use by a user.

6. The tablet system of claim 5 wherein at least two of the plurality of the different template sheets can be simultaneously attached to the input surface in overlying fashion.

7. The tablet system of claim 1, wherein at least one of the indicia is associated with graphical objects that can be displayed on a display device when activated at the input surface using the pointer.

8. The tablet system of claim 1 wherein a plurality of indicia are each associated with a slide in a digital presentation file and wherein an associated slide can be activated to be displayed when a user points at a corresponding indicia.

9. The tablet system of claim 1 wherein at least one of the indicia corresponds to a function that enables a user to drag the pointer across the indicia to scroll through slide presentations displayable on a common display device.

10. The tablet system of claim 1 wherein the tablet system is capable of mapping separate live areas, corresponding to layout information on the input surface, to different images displayable on a display device, and wherein a user can selectively activate the different separate live areas depending on which image the user wishes to display on the display device.

11. A tablet system comprising:
a tablet having an input surface;
a pointer;
a plurality of sensing members for detecting a position of the pointer
proximate the input surface and for generating position detection signals;
a processor operable for receiving position detection data from the tablet based on the position detection signals and for comparing the position detection data against layout information for a template sheet attachable to the input surface;
wherein a plurality of different template sheets can be attached to the input surface, each template sheet having different layout information, and wherein the layout information for each template sheet can be supplied to the processor for selective use by a user; and
wherein any inner and outer portion of the input surface can be associated with one or more indicia for use in activating a function or mode.

12. The tablet system of claim 11 wherein at least two of the plurality of the different template sheets can be simultaneously attached to the input surface in overlying fashion.

13. The tablet system of claim 12 wherein at least one of the template sheets is substantially transparent.

14. The tablet system of claim 11 wherein at least one of the template sheets contains an area marked with indicia associated with particular files, functions or modes which can be opened or initiated by pointing the pointer at the indicia.

15. The tablet system of claim 11, wherein at least one of the template sheets contains indicia associated with graphical objects that can be displayed on a display device when activated at the input surface using the pointer.

16. The tablet system of claim 11 wherein at least one of the template sheets contains an area marked with indicia associated with particular files, functions or modes combined with a graphical object area marked with indicia associated with graphical objects which can be displayed on a display device when activated at the input surface using the pointer.

17. The tablet system of claim 11 wherein at least one of the template sheets contains a plurality of indicia that are each associated with a slide in a digital presentation file and wherein an associated slide can be activated to be displayed when a user points at a corresponding indicia.

18. The tablet system of claim 11 wherein at least one of the template sheets contains indicia on which the pointer can be dragged to scroll through slide presentations displayable on a common display device.

19. The tablet system of claim 11 wherein at least one of the template sheets contains a plurality of separate live areas, and wherein the tablet system is capable of mapping each of the separate live areas to a different image displayable on a display device, and wherein a user can selectively activate the different live areas depending on which image the user wishes to display on the display device.

20. A tablet system comprising:
a tablet having an input surface and compact display;
a pointer;
a plurality of sensing members for detecting a position of the pointer
proximate the input surface and for generating position detection signals;
a processor operable for receiving position detection data from the tablet based on the position detection signals and for comparing the position detection data against layout information for the input surface, the layout information including location information related to indicia for initiating at least one of a function and mode of the tablet system; and
wherein the display is operable to display a plurality of list names from which a user can select, each of the list names being associated with a plurality of files, sub-lists, functions or modes, which a user can select.

21. The tablet system of claim 20 wherein at least one of the plurality of lists is pre-associated to be displayable based on currently viewed file or file segment.

22. The tablet system of claim 20 wherein at least one of the plurality of lists is pre-associated to be displayable based on a response profile as may be generated automatically based on audience responses to an inquiry.

23. The tablet system of claim 20 wherein a plurality of lists are associated with list names and wherein a user can scroll through list names on the display to determine a list to select.

24. A tablet system comprising:
a tablet having an input surface and compact display;
a pointer;
a plurality of sensing members for detecting a position of the pointer proximate the input surface and for generating position detection signals;
a processor operable for receiving position detection data from the tablet based on the position detection signals and for comparing the position detection data against layout information for the input surface, the layout information including location information related to indicia which are selectable for initiating at least one of a function and mode of the tablet system; and
wherein the indicia can be automatically associated with different functions or modes dependent on an active software application.

25. A method for operating a tablet system comprising:
providing a tablet having an input surface;
providing a pointer;
providing a plurality of sensing members for detecting a position of the pointer proximate the input surface and for generating position detection signals;
receiving position detection data from the tablet based on the position detection signals and comparing the position detection data against layout information for a template sheet attachable to the input surface, the layout information including location information related to indicia on the template sheet which are selectable for initiating at least one of a function and mode of the tablet system;
wherein at least one of the locations of indicia can be selectively mapped to a location displayable on a display device.
